(19) United States
(12) Patent Application Publication
(10) Pub. No.: US 2019/0124946 A1
(43) Pub. Date: May 2, 2019

(54) TECHNO-FUNCTIONAL PLANT PROTEIN FRACTION FROM LEGUMINOUS OR OIL SEEDS

(71) Applicant: FRAUNHOFER-GESELLSCHAFT ZUR FOERDERUNG DER ANGEWANDTEN FORSCHUNG E.V., Muenchen (DE)

(72) Inventors: ISABEL MURANYI, Marzling (DE); CLAUDIA PICKARDT, Berlin (DE); DANIELA FLECKENSTEIN, Rain (DE); PIA MEINLSCHMIDT, Wien (AT); PETER EISNER, Freising (DE); UTE SCHWEIGGERT-WEISZ, Freising (DE); ARNE KEITZEL, Hamburg (DE)

(21) Appl. No.: 16/090,638

(22) PCT Filed: Apr. 6, 2017
(86) PCT No.: PCT/EP2017/058187

§ 371 Date: Oct. 2, 2018

(30) Foreign Application Priority Data
Apr. 8, 2016 (DE) 10 2016 106 465.3

(51) Int. Cl. A23J 3/34; A23J 1/14

(52) U.S. Cl. CPC A23J 3/346; A23V 2002/00; A23J 1/148

(57) ABSTRACT

The present invention relates to a plant protein fraction from legumes or oil seeds for use in foodstuffs or in feedstuffs and to a process for producing the plant protein fraction. In the process a first protein fraction is separated from comminuted leguminous seeds or oil seeds using a solvent to leave behind a second protein fraction, and a water-containing protein fraction obtained by this fractionating step directly or after addition of water is subjected to treatment with enzymes one or more times, a heating to a temperature>70° C. one or more times, optionally a fermentation one or more times and a pressure and/or shear treatment one or more times. The plant protein fraction produced with the process exhibits a reduced immunoreactivity and has good techno-functional and organoleptic properties.

### FIELD OF APPLICATION

The invention relates to a plant protein fraction from legumes or oil seeds which contains one or more sub-fractions of proteins of one or more species of legume or one or more species of oil seed, for use in foodstuffs or in feedstuffs, and to a process for producing the plant protein fraction.

### PRIOR ART

Plant proteins are enjoying increasing popularity among consumers. Today, a variety of different plant proteins from legumes, oil seeds or grain are already being used as texturising components. They are used to stabilise emulsions, foams or to form gels or are added in the form of a component, which is usually easily soluble, to foodstuffs or beverages for enrichment with proteins. The variety of protein preparations available on the market however, shows considerable deficiencies in respect of techno-functional properties, particularly in the case emulsifying capacity, solubility or gel-forming properties. A further disadvantage of plant proteins is the fact that a lot of consumers demonstrate a strong immune response or even an allergic reaction when eating plant proteins, for example from soya, peanut or lupin, which previously hindered widespread use of these ingredients. The sensory properties of many plant proteins also do not meet the wishes of consumers. Many plant seeds demonstrate an undesirable flavour and aroma profile on account of contained secondary plant substances or lipid oxidation products. Many preparations from soya, pea or lupin are thus described as being bitter, beany, grassy or green.

For this reason, increasing efforts have been made in the research to modify the plant proteins with the aid of new processes such that both their sensory and their techno-functional and immunoreactive properties satisfy the wishes of the consumer. It previously has not been possible, however, to improve all of the aforesaid attributes equally. Rather, a reduction of the immunoreactivity is accompanied usually by a worsening of the sensory properties or with a reduction in the emulsifying or foaming properties. The prior art in respect of the modification of proteins will be presented briefly hereinafter, and the weaknesses which still existed until now will be discussed. The methods for determining the above-mentioned functional properties will be described further below in this application.

The hydrolysis of plant proteins is a known process for modifying the properties of proteins, such as the techno-functionality (for example protein solubility, emulsifying effect, foam formation) or also the allergenicity of the preparations. Protein hydrolysates based on plant proteins and based on whey proteins are described.

For this purpose, a protein dispersion is for example hydrolysed by the use of individual enzymes or enzyme combinations, and the enzymes are inactivated by a heat treatment. Different protein fractions, primarily the permeate, are then obtained in a downstream process by an ultrafiltration and/or soluble and insoluble proteins are obtained by a separation. Further processing steps, such as a subsequent drying process (for example freeze-drying) of the products follow optionally.

Documents JP11178512, JP2001211851, KR20090119204 and CN101974589 describe the treatment of plant proteins and whey proteins with individual enzymes, however the produced hydrolysates have disadvantages in respect of their sensory or techno-functional properties. Furthermore, the reduction of the allergenicity by the use of a protease is usually insufficient to effectively suppress allergic reactions. In addition, the sensory properties after the hydrolysis with a protease, particularly a high bitterness, are rated negatively.

Similar processes are described in WO9215696 and WO9215697 for plant proteins such as those from soya, rice, sesame, rapeseed, broad bean or pea. Here, the plant protein, protein concentrate or protein isolate is processed with a protein content of at least 65% with water to form a slurry with a protein content of 7-20%. Prior to the hydrolysis, the slurry is heated to >60°. The enzymatic hydrolysis is carried out under optimal pH and temperature conditions with the aid of at least two proteases to a degree of hydrolysis of 15-35% without pH adjustment, and the enzymes are inactivated by a heat treatment following a hydrolysis period of >14 hours. For example, Alcalase (Bacillus licheniformis) and/or Neutrase (Bacillus subtilis) are used, wherein the hydrolysis is performed as a two-stage process. The hydrolysed protein is then obtained as permeate by an ultrafiltration with a cut-off of >5,000 Da (Da: Dalton). Further processing steps follow optionally, such as spray drying for concentration and drying of the products. However, there is no mention of the techno-functional properties or the immunoreactivity. On account of the high degree of hydrolysis, the long treatment with use of Alcalase, and the subsequent ultrafiltration, it must be assumed that the techno-functional properties such as the emulsifying capacity, the foam stability, and the gel formation are much poorer compared to untreated proteins. The inventors of the present invention thus sought to repeat the processes of WO9215696 and WO9215697 and in so doing determined that the emulsifying capacity is reduced by about 30-50% compared to an untreated protein.

Document WO9324020 describes a whey protein hydrolysate having good organoleptic properties and a low allergenicity. In addition to the steps mentioned in WO9215696 and WO9215697, the whey protein is obtained beforehand by acidic precipitation from casein. In addition, a cut-off of >10,000 Da, preferably >50,000 Da is established for the separation by means of ultrafiltration by selection of the membranes. As a result of this process, whey proteins having a low allergenicity are obtained. Due to the fact that in this process an enzyme combination consisting of alcalase and neutrase is used, the techno-functional properties such as the emulsifying and foam-forming properties after the treatment are very poor.

Document EP0421309 describes a process for producing a whey protein hydrolysate and combinations thereof with soy protein or casein. Prior to the enzymatic hydrolysis, large proteins (>50,000 D1) are separated with the aid of the ultrafiltration. Subsequently to the enzymatic hydrolysis with the aid of an enzyme combination, an ultrafiltration with a cut-off of 1,500-15,000 Da is used. However, due to the use of the described enzyme combination, preliminary hydrolysis with pepsin and subsequent hydrolysis with trypsin-chymotrypsin-elastase 2, it can be assumed that the sensory and techno-functional properties are significantly impaired.

Document EP1236405 describes a process for producing hypoallergenic, soya-based products, the antigenicity of which is reduced by the factor 100 (inhibition ELISA). Here, a moderate degree of hydrolysis of <25%, preferably between 10-20% is sought. Individual enzymes of both microbial and plant origin can be used, or a combination thereof. The enzyme-to-substrate ration (E/S) lies between 0.1-10%, and the hydrolysis takes place for between 0.5-10 hours. If an enzyme combination is used—performed as a two-stage process—an inactivation step of the particular enzyme must always occur between the enzyme addition, Following a final inactivation step, the resultant hydrolysate can be separated optionally by ultrafiltration or separation from insoluble proteins. No mention is made of the techno-functional or sensory properties of the products. However, it can be assumed that the use of higher E/S ratios and the use of Alcalase again leads to an impaired techno-functionality of the products. It is additionally known that an Alcalase treatment leads to a high bitterness, which in turn reduces the acceptance among consumers.

A process for producing soluble soya proteins with high functionality and low bitterness is described in EP1512328. A fungus protease or, in the form of a one-stage process, a combination of fungus proteases, which have both endoproteolytic and exoproteolytic activities is used for the hydrolysis of a “soya paste” with 10-20% soya protein. Here, Corolase PM-L (Aspergillus sojae) and Flavourzyme 500 L (Aspergillus oryzae) are cited. After a treatment period of 0.5-5 hors, the enzymes are inactivated by a thermal step and the soluble and insoluble protein fraction are separated from one another by means of centrifugation and are then dried. There is no mention of the immunoreactivity or allergenicity. In addition, merely the soluble protein fraction with its high functionality is emphasised. The insoluble (modified) proteins or the mixed protein fractions are not described in further detail.

Document EP0406598A1 describes a process for reducing the bitterness of enzymatically hydrolysed proteins. Here, protein hydrolysates are subjected to a subsequent fermentation for up to 30 hours at constant pH value in order to weaken the bitterness. The production process and the physicochemical properties of the starting raw material (protein hydrolysate) for the fermentation are not described. Following the inactivation of the enzymes at 65-80° C. and subsequent cooling, the “debittered” samples can be processed either directly in the foodstuff or can be dried beforehand. Since it is known, however, that both the enzymatic hydrolysis and the fermentation can have a negative effect on the techno-functional properties, it must be assumed that the techno-functional properties were significantly impaired. All commercially obtainable hydrolysates previously had a very poor techno-functionality in the sense of the emulsifying and gel-forming properties, and therefore it can be assumed here as well that these properties essential for use in foodstuffs were significantly impaired.

Using soya proteins as an example, P. Meinlschmidt et al. (2017), “High pressure processing assisted enzymatic hydrolysis—An innovative approach for the reduction of soy immunoreactivity”, Innovative Food Science & Emerging Technologies: 40, 58-57, were able to show that an enzymatic hydrolysis, supported by high pressure, of soya protein isolates does not improve the techno-functional or sensory properties. For this reason, a person skilled in the art would not use a pressure treatment in combination with enzymes in order to produce functional and good-tasting soya proteins.

It is additionally described in the literature that the fermentation has a negative influence on the emulsifying properties of legume proteins. P. Eisner, “Extraktive Fraktionierung von Leguminosensamen zur Gewinnung von funktionellen Lebensmittelzutaten am Beispiel der Lupine” (Extractive fractionation of leguminous seeds for recovery of functional foodstuff ingredients on the basis of the example of lupins), postdoctoral qualification, 2014, Munich Technical University, showed that the emulsifying capacity in lupin protein isolates drops from 510 mL/g to values between 385 and 230 mg/L if the protein is fermented with Lb. perolens, Pc. pentosaceus, Lb. plantarum or Lc. paracasei.

Likewise, P. Meinlschmidt et al., “Immunoreactivity, sensory and physicochemical properties of fermented soy protein isolate”, Food Chemistry 205: 229-238, demonstrated in further test series on the basis of the example of soya proteins that a fermentation with different microorganisms (lactic acid bacteria, moulds, yeast cells) lead to a reduction of the techno-functional properties, in particular the emulsifying capacity and the protein solubility at neutral pH value. Here, the emulsifying capacity dropped from 660 mL/g to values between 475-483 mL/g, and the protein solubility at pH 7 dropped from 44.0% to values between 16.5-18.2% when the protein was fermented with Lb. helveticus for 24 and 48 hours. A person skilled in the art wishing to provide a highly functional protein preparation with good emulsifying properties would therefore attempt at all costs to avoid a fermentation as processing step.

According to the prior art, enzyme combinations are thus very often used for the treatment of proteins. For example, a low-molecular fraction is obtained by an ultrafiltration from the resultant hydrolysates, the immunoreactivity of said fraction being described as reduced. Here, however, a significant impairment of the functionality is demonstrated, since the separated small molecule fragments hardly still emulsify, do not form stable foams, and in many cases also have a very bitter and almost repulsive taste.

It was not known previously whether or how it might be possible to produce, from legumes and oil seeds, protein preparations that have good techno-functional properties in respect of the stabilisation of emulsions and foams and the formation of gels as compared to the corresponding untreated proteins, are appealing from an organoleptic viewpoint, and at the same time have a reduced allergenicity or IgE immunoreactivity.

The object of the present invention lies in specifying a plant protein fraction and a process for producing the plant protein fraction from proteins of legumes (for example soya, pea, lupin, bean, chickpea, lentil or peanut) or oil seeds (for example sunflower, rape, camelina or flax), which has a reduced immunoreactivity and at the same time has food techno-functional and organoleptic properties. The produced protein fractions should in particular demonstrate a light colour and good emulsifying properties, and should taste almost neutral, in particular should have low bitterness and a hardly perceptible beany taste. In addition, the process used for this purpose should be economical and should demonstrate a high yield, since according to the prior art often only small fractions of the proteins are usable from the raw materials, which leads to very high costs.

### DISCLOSURE OF THE INVENTION

The object is achieved with the process and the plant protein fraction according to claims 1 and 16, 18 and 20. Advantageous embodiments of the process and of the plant protein fraction are the subject of the dependent claims or can be deduced from the following description and the exemplary embodiment.

Hereinafter, a protein fraction from legumes or oil seeds shall be understood to mean a mixture of different proteins from legume seeds or oil seeds which does not correspond to the protein composition (proportion of different proteins) from the corresponding plant seeds, but instead has a deviating protein composition, in which in particular one or more of the proteins contained in the seeds is/are no longer contained or is/are still contained only in trace form, and which can also contain peptide strands separated from the proteins.

The process according to the invention is characterised by the following steps, proceeding from comminuted leguminous seeds or oil seeds:

a) mechanical separation of a first protein fraction or separation of a first protein fraction with the aid of a solvent, or combination of mechanical and solvent-based separation of a second protein fraction of the comminuted plant seeds in a fractionating step, also referred to hereinafter as the first fractionating step,

b) optionally, if in the first fractionating step there is no water used as solvent: addition of water to the first or second protein fraction so as to form a water-containing protein fraction,

c) hydrolysis of the water-containing protein fraction by means of acid, lye and/or heat, or by treatment with enzymes, preferably with proteases or peptidases, particularly advantageously with enzyme combinations consisting of at least one endopeptidase and at least one exopeptidase, performed as a one- or two-stage process,

d) heating, one or more times, of the water-containing protein fraction at a temperature above 70° C., advantageously above 80° C., particularly advantageously above 90° C.,

e) optionally: fermentation of the enzymatically, chemically or thermally hydrolysed protein fractions, preferably following addition of microorganisms (at least 10⁸ cfu per gram of protein, better still ≥10⁹ cfu per gram of protein, advantageously ≥10¹⁰ cfu per gram of protein; cfu: colony-forming unit) and in the presence of glucose or another carbohydrate that is easily fermented,

f) pressure and/or shear treatment of the water-containing protein fraction, particularly advantageously after the (optional) fermentation and after the heating.

g) Optionally: reduction of the water content of the water-containing protein fraction by a membrane process or a distillation process to increase the dry substance content to a value<12 mass %, advantageously<15 mass % dry substance.

The protein fraction according to the invention obtained by the above steps a)-g) is characterised by excellent techno-functional and sensory properties. It has surprisingly been found that a further step

h) separation of the (modified) water-containing protein fraction according to size or sedimentability, for example by means of centrifugation or membrane filtration with a suitable cut-off,

which is performed after the (optional) fermentation (step e)) or—without fermentation—after the hydrolysis (step c)), has a significant effect on the allergen potential of the new fractions (sediment or retentate fraction and supernatant or permeate fraction) obtained by this separation step. The separation according to size can be implemented for example by various filtration processes, for example membrane filtration (for example filter, microfiltration, ultrafiltration), the separation according to sedimentability by processes that utilise the mass inertia, such as centrifuges, decanters, separators. The separation is preferably performed such that a molecular weight distribution in which molecule sizes are smaller than 25 kDa to an extent of more than 50%, preferably to an extent of more than 70%, particularly advantageously to an extent of more than 90% (supernatant or permeate fraction), or less than 60% are smaller than 25 kDa, preferably less than 50%, particularly preferably less than 20% (sediment or retentate fraction) is obtained in one of the fractions resulting from this separation.

Particularly good protein properties are obtained if the separation in step h) is performed by means of membrane filtration with a cut-off that is less than 30 kDa, advantageously <6 kDa, particularly advantageously <3 kDa. It is particularly advantageous if the separation of the protein fraction is performed according to size or sedimentability in combination with the shear loading before or after the shear loading.

The mechanical and/or solvent-based separation of a protein fraction described under a) is of great importance for the process according to the invention. The mechanical separation for example can be performed as follows: The plant seeds are comminuted and then separated by means of screening and/or sifting into larger and smaller or lighter or heavier particles. One particle fraction or both particle fractions is/are then passed through the process described under b)-h).

Alternatively to or in combination with the mechanical separation, a solvent-based separation can be performed. The seeds or a mechanically pre-treated fraction of the seeds (referred to hereinafter as raw material) are brought into contact with polar or nonpolar solvents, whereby one protein fraction passes into the solvent and another protein fraction remains in the raw material. For example, water, water mixed with acid, supercritical CO2, ethanol, water-ethanol mixtures, and hexane can be used here as solvent. At least one of the protein fractions (first or second protein fraction) is then subjected to the process described under b)-h).

The water-containing (plant) protein fraction according to the invention obtained by the process can be used in the moist state directly in foodstuffs or feedstuffs as a protein ingredient after execution of the cited process steps. The protein fractions according to the invention are considered here—and also hereinafter—to be both the protein fraction obtained by the steps a)-g) and the protein fractions obtained after steps a)-h) (sediment or retentate fraction and supernatant or permeate fraction).

It is advantageous, however, to dry the protein fraction according to the invention prior to use. For this purpose, a spray drying, fluidised bed drying or roller drying should be used advantageously; drying in a vacuum is also possible. Freeze-drying should be avoided where possible, since it has been found in tests that freeze-dried protein fractions have poorer properties than protein fractions from spray drying.

The process steps of hydrolysis, fermentation, pressure treatment, heating, pressure and/or shear loading and filtration/centrifugation can be used in accordance with the invention more than once in different sequences so as to further improve the sensory and functional properties. The fermentation preferably follows the enzyme treatment, and the pressure and/or shear treatment preferably follows the fermentation, wherein the heating steps can be performed at any points of this sequence, i.e. also between fermentation and enzyme treatment and/or between pressure and/or shear treatment and fermentation. In testing, particularly good results were demonstrated with three heating steps to a temperature of more than 80° C. With this process combination, the immunoreactivity could be significantly reduced in addition to the improvement of the techno-functional and sensory properties.

The pressure and/or shear treatment specified under f) is to be performed in the process according to the invention at a pressure above 2*10⁵ Pa (2 bar), advantageously above 5*10⁵ Pa (5 bar), particularly advantageously at a pressure above 150*10⁵ Pa (150 bar). It has been found in tests that with increasing pressure up to a maximum pressure of 1000*10⁵ Pa (1000 bar), which in order to attain the protein functional properties should not be exceeded, and simultaneous shearing (for example with the aid of a homogeniser), the solubility and usually also the emulsifying properties of the water-containing protein fraction can be improved.

In order to examine the efficacy of the filtration/centrifugation in step h), in the case of a fermentation performed during the process, the proportion of the separated microorganisms can be used. In the event of a successful separation process, more than 50 mass % of the microorganisms DNA introduced originally for the fermentation are preferably found in the residue, and less than 20 mass % are found in the supernatant.

Comminuted leguminous seeds or oil seeds which are used in the process according to the invention are understood to be particles or fragments of seeds which are altered by means of a mechanical process (for example mill, roller mill, or the like) in such a way that they no longer have their natural form after the treatment.

In the process according to the invention most of the process steps take place in an aqueous environment. The interaction with the used water is important to the success of the process. If water is used as a solvent for example in the first fractionated step, it should be sought to ensure that this quarter, prior to the fermentation, is not separated again from the protein fraction by a drying process. It has been found in tests that the fermentation of a previously dried protein fraction leads to poorer properties in respect of the emulsifying capacity and water solubility than if the protein fraction in water is treated directly fermentatively without drying and the proteins are surrounded by water during the entire procedure. The fermentation is performed here in accordance with the invention with the aid of microorganisms in an aerobic or anaerobic medium. Microorganisms from the group of lactic acid bacteria (Lb. perolens), yeasts (for example Saccharomyces cerevisiae) or fungus cultures (for example Rhizopus oryzae, Actinomucor elegans) are preferably used.

Without prior drying of the protein fraction, the change to the immunoreactivity during the course of the fermentation is surprisingly also different, although the same microorganisms are used. It should therefore be ensured that, after addition of the water until completion of the fermentation, the proportion of water to protein is where possible higher than 1:1, even better higher than 8:1, particularly advantageously higher than 16:1. A drying step should be performed only subsequently to the pressure/shear treatment according to the invention.

The proteins from the described raw materials treated by means of enzymatic and/or fermentative processes should be water-soluble or at least easily dispersible in water so that the enzymatic treatment can be performed in a controlled manner. The process is particularly advantageously carried out if at least 35% of the protein constituents are dissolved or dispersed in a stable manner at pH 7. For this purpose, the raw materials are mixed, dissolved or dispersed in water and the enzymes are added inappropriate concentrations. The term “dispersed in a stable manner” shall be understood to mean the proportion of dispersed particles in a dispersion that are still in the supernatant above a separated sediment following a sedimentation period of 10 minutes.

The solvent for separating the first protein fraction can consist of water or aqueous solutions or of organic solvents, such as ethanol, hexane, supercritical CO₂, or the like, or can consist of mixtures of organic solvents with water.

It has surprisingly been found that both the immunoreactivity and the sensory and techno-functional properties of the first and second protein fraction can be influenced by this first fractionating step. For example, in the case of soya, if the immune response of patients to the kunitz trypsin inhibitor is particularly strong, the immunoreactive potential of the second protein fraction can be reduced by aqueous separation of a first fraction containing the majority of the kunitz trypsin inhibitor, whereas the emulsifying properties of the second protein fraction can be increased by means of a separation step of this kind.

When working with lupin it has been found that when separating an easily soluble protein fraction by means of solvents, other components which for example bring about a bitter taste or astringency also can be reduced. The stringency and the bitter taste in the second fraction can thus be reduced by this fractionating step, and at the same time the specific immunoreactivity can be changed. The second fraction of the lupin protein remaining in the raffinate after the first extraction is contained with a greater proportion of alpha- and beta-conglutin compared to the starting seed and demonstrates improved emulsifying properties compared to the first fraction.

In tests with the process according to the invention in the case of soya proteins, it has additionally been found that storage proteins, which are contained in high concentrations in the soya bean, such as the glycinin and conglycinin fractions, are particularly well suited for the proposed process. These fractions are frequently separated in the prior art from other soya protein fractions since they demonstrate a particularly high immunoreactivity. Since these fractions account for the greatest proportion of the proteins in the soya bean, the process according to the invention can be carried out very economically, since a very large proportion of the storage proteins can be utilised, which is accompanied by a low specific raw material consumption.

By using the process according to the invention, it is possible to reduce the bitterness (assessed by a trained panel and scored on a scale of from 1 to 10), which in the case of a natural soya protein following extraction and isoelectric precipitation lies at a value of more than 2, to values less than 1 and at the same time to generate pleasant aroma notes in the protein fraction.

The process is particularly advantageous if the mechanical pressure and shear loading and thus combination of protein aggregates is performed after the fermentation. As a result of this treatment step, the mouthfeel of the protein fraction, which after fermentation is often described as rough and sandy, is described as softer and more pleasant.

Advantageous techno-functional properties alongside a significant reduction in immunoreactivity are provided if, after the first fractionating step, a 2-stage enzymatic hydrolysis by means of endo- and exopeptidases is performed with the water-containing protein fraction, followed by a fermentation preferably with lactic acid bacteria, the protein fraction is then treated at a pressure of more than 2*10⁵ Pa (2 bar), and the protein fraction is then dried preferably in a spray dryer, wherein at least 2 heating steps above 85° C. are carried out during the course of the process. As a result of this process combination, the protein solubility at pH 7 is increased to values of partly more than 50% with simultaneous minimisation of the immunoreactivity and reduction of bitterness. Above all, the reduction of the bitter taste is surprising, since previously an increase in the solubility of protein preparations by enzymatic hydrolysis was described always with an increase in the bitterness (see Seo et al., “Evaluation of bitterness in enzymatic hydrolysates of soy protein isolate by taste dilution analysis”, Journal of Food Science, 73(1), 2008, p. 41-46).

Since, in many cases, a high pressure loading is not desired for economical or energy reasons, simpler processes can also lead to a good product according to the invention. It has thus been found that satisfactory results are retained also at low pressures close to ambient pressure if an intense shear loading is ensured. This can occur for example at gaps through which a fluid passes rapidly, and moving edges, at the points of contact of agitators in liquids, also in high-performance pumps. It has been found in tests that a shear loading according to the invention is achieved when shear rates occur that are greater than 10 s⁻¹, advantageously greater than 100 s⁻¹, particularly advantageously greater than 500 s⁻¹.

In some applications it can be advantageous to perform a heating of the corresponding protein fraction to more than 90° C., even better to temperatures of more than 100° C. Here, besides an extensive reduction of the seed load in the protein fraction, further sensory effects can also be attained by thermally induced reactions and have a positive influence on consumer acceptance. Similarly positive effects can be attained with a number of heating steps. The protein fraction during the course of the treatment is advantageously heated more than once to values of more than 80° C., particularly advantageously more than 3 times.

Particular advantages in respect of selected techno-functional properties, such as solubility or emulsifying capacity, are provided if, after the hydrolysis and (optional) fermentation, a separation step according to size or solubility or sedimentability is performed, for example a centrifugation or filtration. Here, it has been found that the protein fraction in the sediment, compared to the protein fraction in the supernatant, differs greatly in respect of the functionality and immunoreactivity following the centrifugation in spite of similar sensory properties.

Whereas the protein fraction in the sediment has much better properties as emulsifier than the protein fraction in the supernatant, it produces a stronger allergic reaction in prick tests in corresponding allergy sufferers compared to the protein fraction of the supernatant. The same is true for the retentate and permeate protein fractions following the ultrafiltration. Here as well, the retentate fraction is better suited as emulsifier, but produces stronger allergic reactions in prick tests in the human skin.

The protein fractions according to the invention obtained when the separation step h) is included in the process are the retentate fraction or sediment fraction and the permeate fraction or supernatant fraction.

The protein fraction according to the invention contains more than 25 mass % protein, preferably more than 60 mass %, particularly advantageously more than 90 mass %. It is characterised in that one or more sub-fractions of the proteins of one or more species of legume or one or more species of oil seed is/are contained. Here, the term “leguminous seeds” is understood to mean seeds of soya, pea, lupin, chickpea, lentil, bean, broad bean and peanut, and the term “oil seeds” is understood to mean seeds of sunflower, rape, camelina and flax. The protein fraction according to the invention can consist of one sub-fraction or a mixture of a number of sub-fractions of the respective totality of proteins from the cited raw materials.

In accordance with the invention, the protein fraction after fermentation comprises a proportion of biomass from microorganisms which are present advantageously in the inactivated state. This proportion in the dry substance content, in relation to the dry substance content of the protein fraction, is greater than 0.05 mass %, even better greater than 0.5 mass %, particularly advantageously greater than 1 mass %. It has been found that an enrichment of the biomass from lactic acid bacteria up to a proportion of 1 mass % of microorganism dry mass of the protein fraction is found to be increasingly pleasant from a sensory viewpoint. The approval decreases again at higher concentrations.

The protein fraction according to the invention preferably consists of a proportion of protein that is soluble at pH 7 and of a proportion of protein that is insoluble at pH 7. The soluble proportion of the protein fraction surprisingly has a narrow molecular weight distribution. The molecule sizes in this case are smaller than 25 kDa to an extent of more than 30%, preferably to an extent of more than 50%, particularly preferably to an extent of more than 90%. The properties of the proteins of the soluble proportion are therefore very uniform. It would thus appear possible to separate the soluble fraction at a pH value of 7 from the insoluble fraction and to use both protein fractions separately from one another. Particularly for the soluble fraction, there are a large number of application possibilities in foodstuffs, for example a use in beverages or gels.

When incorporating separation step h) in the production process, the protein fraction according to the invention is formed merely by the permeate or supernatant fraction or by the retentate or sediment fraction and then has a molecular weight distribution in which molecule sizes either are smaller than 25 kDa to an extent of more than 50%, preferably to an extent of more than 70%, particularly advantageously to an extent of more than 90%, or in which less than 60% of the molecule sizes are smaller than 25 kDa, preferably less than 50%, particularly preferably less than 20%.

The protein fraction according to the invention advantageously has a foam activity (in relation to a starting solution) of greater than 1000%, preferably greater than 1500%, particularly preferably greater than 2000%. The emulsifying capacity is preferably>200 ml oil/g protein, particularly advantageously>500 ml oil/g protein, and preferably has—after sufficient pressure and shear treatment—a solubility of>25% at pH 7.

In order to increase consumer acceptance, the protein fraction used for the application in foodstuffs, besides pleasant properties in respect of aroma and taste, also has a distinctive brightness. This is specified by the L-value in the L*a*b determination used for the colour characterisation. In the case of the protein fraction according to the invention, this value is above 70, preferably above 80, particularly advantageously above 90.

The colour of the protein fraction in accordance with the invention is thus very light and depending on the predominantly contained raw material ranges from white, through cream colours, light grey, light yellow or light orange. The following are typical values for L*, a* and b*

L*≥80, −5<a*<+5, −5<b*<+20; advantageously

L*≥85, −3<a*<+3, −2<b*<+15; particularly advantageously

L*≥90, −1<a*<+1, 0<b*<+10.

In addition, the protein fraction advantageously contains a proportion of aroma components which originate from the fermentation, such as diacetyl or other metabolites of the fermentative treatment.

The immunoreactivity of the product according to the invention is reduced by at least 50%, even better by >80% as compared to a native protein from the same plant. This value is determined via Western Blot evaluation.

With the production process according to the invention, protein fractions having the following properties can be produced from plant proteins:

Techno-functional properties:

it has been found that the techno-functional properties of the protein fraction were significantly improved by the process steps according to the invention. The following values were found typically in the protein fractions:
Protein solubility at pH 4:
The protein solubility, determined in accordance with Morr et al. (Morr et al. 1985, “A Collaborative Study to Develop a Standardized Food Protein Solubility Procedure”, Journal of Food Science 50:1715-1718), is greater than 5%, preferably greater than 20%. The protein solubility typically lies in the range of >5-900.
Protein solubility at pH 7:
The protein solubility, determined in accordance with Morr et al. 1985 is preferably greater than 25%, preferably greater than 50%. The protein solubility typically lies in the range of >35-90%.
Emulsifying properties:
The emulsifying capacity, determined in accordance with the conductivity measurement method, is at least 200 ml oil/g, preferably at least 500 ml oil/g.
Water- and oil-binding capability:
The water binding, determined in accordance with the AACC determination process, is at least 2 ml/g, preferably at least 3 ml/g.
The oil binding, determined in accordance with the fat-binding determination process, is at least 1 ml/g, preferably at least 2 ml/g.
Foam-forming properties:
The foam activity is at least 1000%. Comparative measurements with fresh chicken egg white beaten for 3 minutes at level 3 in a Hobart 50N standard stand mixer with the whisk attachment show that the fame activity of the protein fraction corresponds to at least 60% of the foam activity of chicken egg white. The foam density lies in the range of from 30 to 220 g/l. The foam stability is at least 2%, preferably at least 50%.

Sensory properties:
Besides the light colour, the protein fraction is substantially odour-free and has a neutral taste. In particular, the inherent plant or seed aromas are largely absent. There is thus substantially no “beany” and “green/grassy” smell or taste, and there is substantially no perceptible bitter taste.
Sensory tests performed by a trained sensory panel demonstrate that the protein fraction is assigned a value of 2 or less (typically a value of from 0 to 1). Colour, inherent taste and inherent smell of the protein fraction are such that, when incorporated into foodstuffs and feedstuffs, there is substantially no significant change, ascertained using conventional statistical methods and assessed negatively, to the intrinsic appearance, smell or taste of the finished preparation.
The colour, inherent taste and inherent smell of the protein fraction are such that, when incorporated into foodstuffs and feedstuffs, there is substantially no significant change, ascertained using conventional statistical methods and assessed negatively, to the intrinsic appearance, smell or taste of the finished preparation.
Sensory tests show that the taste and aroma change brought about in a foodstuff preparation by the use of the protein fraction, compared to the foodstuff preparation without the protein fraction, is limited to such a level that a trained tester can identify a deviation of one of the above-mentioned taste or aroma features on a scale of 1-10 of at most level 3, even better at most level 1 (almost imperceptible deviation).

The protein fraction according to the invention can therefore have one or more of the above techno-functional and sensory properties.

The protein fraction according to the invention is preferably used as a foodstuff ingredient. Since, in addition to the improved functionality and sensory properties, the immunoreactivity of the protein fraction according to the invention is also significantly reduced, the protein fraction from a raw material (for example soya or sunflower) or mixtures of various raw materials can be used advantageously as a hypoallergenic or allergen-reduced protein ingredient in foodstuffs.

Due to the high functionality of the protein fraction, the use amount for attaining the desired texture effects (for example stabilisation of an emulsion) compared to protein ingredients previously available on the market can additionally be further reduced, such that a lower immunoreactivity of the protein fraction together with a smaller use amount of the ingredient will lead to a weaker immune response in individuals who are potentially allergic. Applications such as emulsions (for example plant substitute for milk, cream, yoghurt, cheese, sausage, mayonnaise, etc.), plant-based baked goods, fine pastries and pasta products in which the egg ingredients is omitted, or extruded wet or dry protein products (for example plant-based meat alternatives from cooking extrusion or plant-based dry extrudates).

Exemplary Embodiment

A soya protein fraction was obtained which was extracted by means of aqueous extraction at pH 8 from ground soya beans pre-extracted with water and was concentrated with precipitation at the isoelectric point. The obtained suspension was neutralised and set to a protein: water ratio of 1:20. The following process steps were then performed:
enzymatic hydrolysis (two-stage enzyme combination of endopeptidase and exopeptidase) at 30° C., followed by a
heating to 85° C., followed by an
aerobic fermentation by means of lactic acid bacteria (Lb. perolens), with prior addition of 2% glucose, followed by a
homogenisation of the respective fractions at a pressure of 200*10⁵ Pa (200 bar) and a temperature of 30° C. and a
subsequent spray drying.

The protein fraction obtained has an almost white colour, a very natural taste and, in a sandwich ELISA and Western Blot with specific monoclonal mouse antibodies and human sera from individuals allergic to soya, does not have any immunoreactivity, or only has a very low immunoreactivity compared to the native protein, but at the same time has functionality values in respect of emulsifying capacity of 700 mL oil/g and 50% solubility at pH 7.

Determination process:

The following determination process was used for quantitative characterisation of the produced protein fraction:
Protein content:

The protein content is defined as the content calculated from the determination of nitrogen (N) and multiplication thereof by the factor 6.25. The protein content is stated for example in percent in relation to the dry mass (DM).
Colour: the perceptible colour is defined by means of CIE-L*a*b*-colour measurement (see DIN 6417). Here, the L* axis indicates the brightness, wearing black has the value 0 and white has the value 100, the a* axis describes the green or red component, and the b* axis describes the blue or yellow component.
Protein solubility (at pH 7 or pH 4):

The proteins are abilities determined by means of determination processes according to Morr (Morr et al., “A Collaborative Study to Develop a Standardized Food Protein Solubility Procedure”, Journal of Food Science 50:1715-1718). Here, the protein fraction with a mass-volume fraction of 1:25 to 1:50 (w/v) (i.e. 1-2 g of the protein fraction to 50 ml solution) is suspended in a 0.1 M NaCl solution at room temperature and is held with used of a 0.1 M HCl or NaOH solution for approx. 60 min at a pH value of pH 7 (or pH 4) and stirred at approx. 200 rpm, and the insoluble sediment is then centrifuged off for 15 min at 20,000×g. The protein solubility is specified for example in percent, wherein a protein solubility of x% means that x% of the protein present in the protein fraction can be retrieved in the clarified supernatant if the described method is applied.
Water binding:

The water-binding capability is defined by means of determination processes (here AACC determination process) as specified in: American Association of Cereal Chemists, “Approved methods of the AACC”. 10th ed., AACC. St. Paul, Minn., 2000; Method 56-20. “Hydration capacity of pregelatinized cereal products”. The water-binding capability is for example specifiable in ml/g, i.e. millilitres of bound water per gram of protein fraction, and is determined in accordance with the AACC determination process via the weight of the sediment saturated with water minus the weight of the dry protein fraction after mixing of approx. 2 g protein fraction with approx. 40 ml water for 10 minutes and centrifugation at 1000 g for 15 minutes at 20° C.
Oil binding:

The oil-binding capability is determined by means of determination processes (here referred to as a fat-binding determination process), as specified in: Ludwig I. et al., “Eine Mikromethode zur Bestimmung der Fettbindkapazitat” (A micromethod for determining the fat-binding capacity). Nahrung/Food, 33(1), 99. The oil-binding capability is specified for example in ml/g, i.e. millilitres of bound oil per gram of protein fraction, and is measured in accordance with the above-mentioned determination process as volume of the oil-binding sediment after mixing of 1.5 g protein fraction with 15 ml corn oil for 1 minute and centrifugation at 700 g for 15 minutes at 200 C.
Emulsifying capacity:

The emulsifying capacity is determined by means of determination processes (referred to here as a conductivity measurement method) in which 100 ml, pH 7, corn oil is added to a 1% suspension of the protein fraction until phase conversion of the oil-in-water emulsion. The emulsifier capacity is defined as the maximum oil take-up capacity of this suspension, determined via the spontaneous reduction of conductivity with phase inversion (Wäsche A. et al.,“New processing of lupin protein isolates and functional properties”. Nahrung/Food 45:393-395) and is specified for example in ml oil/g, i.e. millilitres of emulsified oil per gram of protein fraction.
Foam activity:

The foam activity is specified in percent, measured as volume increase of a 5% protein solution, pH 7, when beaten for 8 min at level 3 (591 rpm) in a Hobart 50 N standard stand mixer (steel bowl with 5 litre content) with the whisk attachment (wire whisk).
Foam density:

The foam density is specified in g/l, i.e. mass of foam per unit of volume, and is measured after beating of a 5% protein solution, pH 7, for 8 min at level 3 (591 rpm) in a Hobart 50N standard stand mixer (steel bowl with 5 litre content) with the whisk attachment (wire whisk).
Foam stability:

The foam stability is specified in percent, measured as remaining volume of 100 ml foam within one hour after beating a 5% protein solution, pH 7, for 8 min at level 3 (591 rpm) in a Hobart 50 N standard stand mixer (steel bowl with 5 litre content) with the whisk attachment (wire whisk).
Gel-forming concentration:

Die gel-forming concentration is defined by determination processes as specified in: Sathe S K et al., “Functional-properties of Winged Bean 620 [Psophocarpus-Tetragonolobus (L) Dc] Proteins”. Journal of Food Science 47(2):503-621 509.
Molecular weight distribution:

The molecular weight distribution is defined by means of determination processes (referred to here as SDS-PAGE analysis), as is specified in: Laemmli, “Cleavage of structural proteins during assembly of head of bacteriophage-T4”. Nature, 227, 680). The separation of the proteins is performed by means of 4-20% midi Criterion™ TGX Stain-Free™ precast gels (Bio-Rad Laboratories, Munich, Germany) in the Criterion™ Cell (Bio-Rad Laboratories, Munich, Germany), and the visualisation and evaluation are performed here with the aid of the Gel Doc™ EZ Imager (Bio-Rad Laboratories, Munich).
Degree of hydrolysis:

The degree of hydrolysis is defined by means of determination processes (referred to here as DH value analysis), as is specified in: Nielsen P. M. et al., “Improved method for determining food protein degree of hydrolysis”. Journal of Food Science 66:642-646.
Immunoreactivity:

The immunoreactivity is defined by means of determination processes (Sandwich ELISA and Western Blot) as specified in: Meinlschmidt P. et al., “Immunoreactivity, sensory and physicochemical properties of fermented soy protein isolate”, Food Chemistry 205: 229-238.
Sensory properties:

Sensory tests in which trained testers compare a certain taste or aroma impression of the protein fraction and a suitable reference substance and score on a scale of from 1 to 10 (1=imperceptible, 10=heavily perceptible), wherein two reference substances are selected such that they score 5 and 10 for their taste or aroma impression to be tested.
The microorganisms can be quantified with the aid of microscopic processes or by quantification of the DNA strands of the microorganisms contained in the protein fraction. The DNA strands are quantified using a method from the field of molecular biology which is known by the term “quantitative PCCR”. The amount of DNA in the residue is determined via the quantitative PCRC and can consequently be correlated with the originally used cell count, wherein the cell count is equated with the cfu.

Examples of taste or aroma impressions to be tested are:
beany taste compared to soya beans;
green to grassy taste compared to green paprika or green peas;
bitter taste compared to two aqueous 1.0 and 2.5% aqueous alcalase-hydrolysate solutions (production conditions: E/S=0.5%, 180 min, pH 8.0, 60° C., without pH value adjustment). The panel was selected beforehand by means of a sensory threshold test for identifying “bitter and not bitter tastes” with the aid of caffeine solutions.

1. A process for producing a plant protein fraction from legumes or oil seeds, in which in a fractionating step a first protein fraction is separated from comminuted leguminous seeds or oil seeds using a mechanical process and/or using a solvent to leave behind a second protein fraction and a water-containing protein fraction obtained by this fractionating step directly or after addition of water is subjected to
a hydrolysis one or more times,
a heating to a temperature>70° C. one or more times,
optionally a fermentation one or more times and
a pressure and/or shear treatment one or more times in order to obtain the plant protein fraction.

2. The process according to claim 1, characterised in that
after the hydrolysis, during the further course of the process, the water-containing protein fraction is separated depending on the size or sedimentability into a retentate or sediment fraction and a permeate or supernatant fraction in order to obtain the plant protein fraction.

3. The process according to claim 1
characterised in that
water or an aqueous solvent is used as solvent in the fractionating step, whereby the water-containing protein fraction is obtained directly as first protein fraction.

4. The process according to claim 1
characterised in that
no water or aqueous solvent is used as solvent in the fractionating step and the water-containing protein fraction is obtained by adding water to the first or second protein fraction.

5. The process according to claim 1,
characterised in that
a water content of the water-containing protein fraction is reduced by a membrane process or a distillation process in order to increase the dry substance content to a value up to 12 mass %, advantageously up to 15 mass % dry substance.

6. The process according to claim 1,
characterised in that
the hydrolysis of the water-containing protein fraction is performed with proteases or peptidases.

7. The process according to claim 6,
characterised in that
the hydrolysis of the water-containing protein fraction is performed with enzyme combinations consisting of at least one endopeptidase and at least one exopeptidase.

8. The process according to claim 6,
characterised in that
the hydrolysis of the water-containing protein fraction is performed by a 2-stage enzymatic hydrolysis by means of endopeptidases and exopeptidases.

9. The process according to claim 1,
characterised in that
the fermentation is performed after addition of microorganisms for the fermentation at a dosage of ≥10¹⁰ cfu per gram of protein and in the presence of glucose or another easily fermented carbohydrate.

10. The process according to claim 1,
characterised in that
the pressure and/or shear treatment is performed after the fermentation and after the heating.

11. The process according to claim 1,
characterised in that
the water-containing protein fraction or a retentate or sediment fraction or permeate or supernatant fraction obtained therefrom is dried after execution of the steps of enzyme treatment, heating, fermentation and pressure and/or shear treatment.

12. The process according to claim 1,
characterised in that
the pressure and/or shear treatment is performed at a pressure above 5*10⁵ Pa, preferably at a pressure above 150*10⁵ Pa.

13. The process according to claim 1,
characterised in that
the shear treatment is performed such that shear rates of more than 10 s⁻¹, advantageously more than 100 s⁻¹, particularly advantageously more than 500 s⁻¹ occur.

14. The process according to claim 1,
characterised in that
a water content of the water-containing protein fraction is selected such that a mass ratio of water to protein in the water-containing protein fraction is higher than 1:1, advantageously higher than 8:1, particularly advantageously higher than 16:1 until completion of the fermentation.

15. The process according to claim 1,
characterised in that
the water-containing protein fraction is heated more than twice to a temperature>80° C.

16. A plant protein fraction from legumes or oil seeds which
contains one or more sub-fractions of proteins of one or more species of legume or one or more species of oil seed,
has a protein content of more than 25 mass % protein, advantageously higher than 60%, particularly advantageously higher than 90%, and
has a molecular weight distribution in which more than 30% of the molecule sizes are smaller than 25 kDA, preferably more than 50%, particularly preferably more than 90%,
consists of a proportion of protein which at pH 7 is soluble to an extent of at least 25%, preferably to an extent of at least 50%, particularly preferably to an extent of at least 60%, and
has a foam activity of greater than 1000%, preferably greater than 1500%, particularly preferably greater than 2000%.

17. The plant protein fraction according to claim 16,
which contains DNA strands of microorganisms which correspond to a microorganism concentration of more than 10⁸ cfu per g protein, preferably more than 10⁹ cfu per gram of protein, particularly preferably more than 10¹⁰ cfu per gram of protein.

18. A plant protein fraction from legumes or oil seed which
contains one or more sub-fractions of proteins of one or more species of the legumes or one or more species of the oil seed,
has a protein content of more than 50 mass % protein, advantageously higher than 60%, and
has a molecular weight distribution in which molecule sizes are smaller than 25 kDA to an extent of more than 50%, preferably to an extent of more than 70%, particularly preferably to an extent of more than 90%,
has a solubility which at pH 7 is more than 60%, preferably more than 70%, particularly preferably more than 80%, and
has a foam activity of greater than 1000%, preferably greater than 1500%, particularly preferably more than 2000%.

19. The plant protein fraction according to claim 18,
which contains DNA strands of microorganisms which correspond to a microorganism concentration of more than 10⁶ cfu per g protein, preferably more than 10⁷ cfu per g protein.

20. A plant protein fraction from legumes or oil seeds which
contains one or more sub-fractions of proteins of one or more species of legume or one or more species of oil seed,
has a protein content of more than 50 mass % protein, advantageously higher than 60%, particularly advantageously higher than 90%, and
has a molecular weight distribution in which less than 60% of the molecule sizes are smaller than 25 kDa, preferably less than 50%, particularly preferably less than 20%,
has a solubility which at pH 7 is more than 60%, preferably more than 50%, particularly preferably less than 40%, and
has a foam activity of greater than 1000%, preferably greater than 1500%, particularly preferably more than 2000%.

21. The plant protein fraction according to claim 20, which contains DNA strands of microorganisms which correspond to a microorganism concentration of more than 10⁸ cfu per g protein, preferably more than 10⁹ cfu per g protein, particularly preferably 10¹⁰ cfu per g protein.

22. The plant protein fraction according to claim 17, characterised in that the proportion of biomass from microorganisms is present in inactivated form.

23. The plant protein fraction according to claim 17,
characterised in that
the proportion of biomass from microorganisms is greater than 0.5 mass % in relation to the dry substance content of the plant protein fraction.

24. The plant protein fraction according to claim 17,
characterised in that
the biomass from microorganisms is enriched with lactic acid bacteria or yeasts or moulds up to a proportion of 1 mass % in relation to the dry substance content of the plant protein fraction.

25. The plant protein fraction according to claim 16, characterised in that
the plant protein fraction has an emulsion capacity of >200 ml oil/g protein.

26. The plant protein fraction according to claim 16, characterised in that
the plant protein fraction has a brightness with an L value>70 determined by means of CIE-L*a*b colour measurement.

27. The plant protein fraction according to claim 16, characterised in that
the plant protein fraction contains a proportion of aroma components from a fermentation.

28. The plant protein fraction according to claim 16, characterised in that
an immunoreactivity of the plant protein fraction determined via a Western Blot evaluation is reduced by at least 50% compared to a native protein from the same plant.

29. Foodstuffs or feedstuffs comprising the plant protein according to claim 16.

30. The process according to claim 1, further comprising
adding the plant protein fraction as an ingredient for foodstuffs or feedstuffs.
